(19) United States
(12) Patent Application Publication
(10) Pub. No.: US 2024/0239927 A1
(43) Pub. Date: Jul. 18, 2024

(54) ORGANIC PEROXIDE EMULSION

(71) Applicant: ARKEMA FRANCE, COLOMBES (FR)

(72) Inventors: Markus BRANDHORST, PIERRE-BENITE CEDEX (FR); Jürgen LOHR, Günzburg (DE)

(21) Appl. No.: 18/290,299

(22) PCT Filed: Nov. 24, 2021
(86) PCT No.: PCT/FR21/52090

§ 371 Date: Nov. 12, 2023

(30) Foreign Application Priority Data
May 20, 2021 (WO) PCT/FR2021/050927
May 20, 2021 (WO) PCT/FR2021/050928

(51) Int. Cl. C08F 14/06

(52) U.S. Cl. CPC C08F 14/06

(57) ABSTRACT

The invention relates to an organic peroxide emulsion comprising at least one organic peroxide, at least one emulsifier comprising at least one nonionic surfactant comprising at least one fatty chain and having an HLB of less than or equal to 18, at least one antifreeze with a dynamic viscosity at 20° C. ranging from 40 mPa·s to 100 mPa·s, and water. The invention also relates to a process for preparing such an emulsion, to the use of such an emulsion for the polymerization or copolymerization of one or more ethylenically unsaturated monomers, and also to a halogenated vinyl polymer obtained by using such an emulsion.

### FIELD OF THE INVENTION

The present invention relates to organic peroxide emulsions, to a process for preparing same and to the use thereof for the polymerization or copolymerization of one or more ethylenically unsaturated monomers. The invention also relates to a halogenated vinyl polymer prepared in the presence of such emulsions.

### TECHNICAL BACKGROUND

Organic peroxides, in liquid or solid form, are commonly used as initiators for the polymerization of ethylenically unsaturated monomers for the synthesis of various types of polymers.

However, their use frequently presents a certain number of problems. Specifically, organic peroxides are usually highly unstable species since they decompose relatively easily under the action of a slight input of heat, of mechanical energy (friction or impact) or of incompatible contaminants. Thus, in the event of an uncontrolled elevation of their storage temperature, certain organic peroxides can undergo an autoaccelerated exothermic decomposition which can result in fires and/or violent explosions. In addition, under these conditions, some of these organic peroxides can release combustible vapors that are capable of reacting with any source of ignition, which can drastically increase, or even accelerate, the risks of violent explosion. As a result, it is important to take appropriate precautionary measures in terms of safety during the storage and transportation of organic peroxides.

In order to overcome these drawbacks, organic peroxides are notably conditioned in the form of aqueous emulsions comprising antifreezes. Thus, the presence of water makes it possible both to absorb and to dissipate the energy generated in the event of exothermic decompositions of organic peroxides, while the role of the antifreeze is to keep the emulsion in liquid form, at temperatures below −10° C., generally below −15° C., which makes it possible to limit the risks of an involuntary exothermic decomposition of organic peroxides.

The aqueous emulsions generally also contain an emulsifier having the advantage of lowering the interfacial tension between the aqueous phase and the organic peroxide for the purpose of facilitating the dispersion of the peroxide in the form of droplets and of maintaining the size of said droplets over time. Specifically, over time, the peroxide droplets may sediment, form a cream, or undergo Ostwald ripening, or may agglomerate together, bringing about an increase in their mean size and in their maximum size, which can result, in certain cases, in total or partial phase separation and consequently in an overall destabilization of the emulsion.

In the light of the foregoing, aqueous organic peroxide emulsions must therefore be stable for safety reasons not only during their production but also for a relatively long period of time corresponding to their transportation and storage before being used as polymerization initiators. For this purpose, as indicated above, the organic peroxide droplets must mainly have a mean size and a maximum size that are small and stable over time.

Thus, the peroxide droplets of an organic peroxide emulsion should have a small mean size and preferably a homogeneous size distribution, and should be stable over time, preferably over a period of at least six months. In particular, the maximum diameter of these droplets should very preferentially not be less than 20 μm.

Moreover, in addition to the safety considerations due to the destabilization phenomenon described above, it is essential to obtain homogeneous emulsions with a small droplet size also for considerations of quality and efficiency of the polymerization process. The reason for this is that the use of a non-homogeneous organic peroxide emulsion or an emulsion with an excessively large droplet size as polymerization initiator in an emulsion or suspension of vinyl monomer may produce inhomogeneity in the final product. This inhomogeneity is generally characterized by polymer particles that are poorly gelled during implementation in molten form (“fish eyes”, hard grains). Now, the presence of hard grains opacifies the polymer material. These stability considerations are thus very important for applications in which the transparency of the final product is imperative, notably for medical applications.

Furthermore, the use of non-homogeneous organic peroxide emulsions, i.e. emulsions having a significant difference in organic peroxide concentration distributed between the upper and lower part of the aqueous phase, can also give rise to unpredictable differences in initiator concentration in the polymerization reactor. A difference in initiator concentration in the polymerization reactor can cause a problem regarding the polymerization time. A concentration that is too low reduces the productivity of the reactor since the polymerization time is extended, and can have an impact on the quality of the polymer. A concentration that is too high causes a very substantial release of energy by the polymerization and thus poses the problem of evacuating this energy. The temperature of the polymerization reactor must then be controlled by the various cooling means, such as the jacket, refrigerated counter-blades or a condenser, or else, if the temperature is not well controlled, the polymerization operation must be stopped.

In addition, the steps of discharging the emulsion in intermediate storage silos, of pumping and of introduction of an organic peroxide emulsion into a polymerization reactor are steps that are important for the quality of the polymer obtained, the reliability of the polymerization process and the productivity. These handling steps must be performed in a short time. To do this, it is important for the peroxide emulsion to have a low viscosity so that the flow of the emulsion is facilitated.

Thus, an organic peroxide emulsion should advantageously have a flowability measured by a consistometric cup technique of less than or equal to 200 seconds (measured, for example, according to the standard DIN 53211, with a viscosity cup diameter of 4 mm and a temperature of 5° C.). Various organic peroxide emulsions have been developed.

However, there is a real need to provide an organic peroxide emulsion which remains stable and relatively homogeneous over a long period of time and which allows a small droplet size to be maintained.

### SUMMARY OF THE INVENTION

The invention relates firstly to an organic peroxide emulsion comprising:
at least one organic peroxide;
at least one emulsifier comprising at least one nonionic surfactant comprising at least one fatty chain and having an HLB of less than or equal to 18;
at least one antifreeze with a dynamic viscosity at 20° C. ranging from 40 mPa·s to 100 mPa·s;
from 0 to 1% of polyvinyl acetate;
water;
   and in which, when said emulsion comprises at least one alcohol chosen from the group consisting of methanol, ethanol, ethylene glycol and diethylene glycol, said alcohol is present in a mass ratio strictly less than 1, preferably less than 0.9, more preferentially less than 0.7 and more preferentially less than 0.5, relative to said at least one antifreeze with a dynamic viscosity at 20° C. ranging from 40 mPa·s to 100 mPa·s.

In certain embodiments, the emulsion consists of the at least one organic peroxide, the at least one emulsifier, the at least one antifreeze, water, optionally an organic solvent, and optionally one or more additives chosen from the group consisting of antifoams, chain-transfer agents, chain extenders, pH regulators, plasticizers, and mixtures thereof, said emulsion not being one of the above excluded compositions.

In certain embodiments, the at least one antifreeze is an alcohol, preferably chosen from the group consisting of diols and mixtures thereof.

In certain embodiments, the at least one antifreeze is chosen from the group consisting of propane-1,2-diol, propane-1,3-diol, triethylene glycol and mixtures thereof, preferably propane-1,2-diol.

In certain embodiments, the at least one antifreeze comprises, and preferably consists of, a mixture of propane-1,2-diol and 2-propanol, the mass ratio of propane-1,2-diol to 2-propanol preferably being strictly greater than 1.

In certain embodiments, the mass ratio of propane-1,2-diol to 2-propanol is strictly greater than 1 and less than 4, preferably strictly greater than 1 and less than 2.

In certain embodiments, the at least one antifreeze is present in an amount of from 10% to 40% by weight, preferably from 15% to 25% by weight, more preferably from 17% to 22% by weight, relative to the total weight of the emulsion.

In certain embodiments, the at least one organic peroxide is chosen from the group consisting of peroxydicarbonates, peroxyesters, diacyl peroxides and combinations thereof.

In certain embodiments, the at least one organic peroxide is chosen from the group consisting of tert-amyl peroxypivalate, tert-butyl peroxypivalate, tert-butyl peroxyneodecanoate, tert-amyl peroxyneodecanoate, 3-hydroxy-1,1-dimethylbutyl peroxyneodecanoate, cumyl peroxyneodecanoate, di-sec-butyl peroxydicarbonate, bis(2-ethylhexyl) peroxydicarbonate, bis(3,5,5-trimethylhexanoyl) peroxide, and mixtures thereof.

In certain embodiments, the at least one organic peroxide is present in a content ranging from 40% to 80% by weight, preferably from 44% to 65% by weight, more preferably from 45% to 60% by weight, relative to the total weight of the emulsion.

In certain embodiments, the at least one nonionic surfactant is chosen from the group consisting of oxyalkylenated fatty alcohols, oxyalkylenated fatty acids, oxyalkylenated plant or animal oils, polysorbates, sorbitan esters, alkyl glucosides, oxyalkylenated alkyl glucosides and mixtures thereof. Preferably, the emulsion according to the invention is not:
a composition consisting of: 50% by weight of di-sec-butyl peroxydicarbonate, 1.44% by weight of ethoxylated castor oil with a mean degree of ethoxylation of 31 and 21.4% by weight of propane-1,2-diol, the remainder being water;
a composition consisting of: 50% by weight of di-sec-butyl peroxydicarbonate, 1.5% by weight of ethoxylated castor oil with a mean degree of ethoxylation of 20 and 21.4% by weight of propane-1,2-diol, the remainder being water;
a composition consisting of: 50% by weight of di-sec-butyl peroxydicarbonate, 1.5% by weight of ethoxylated castor oil with a mean degree of ethoxylation of 20, 21.4% by weight of propane-1,2-diol and 3% of 3-hydroxy-1,1-dimethylbutyl peroxyneodecanoate, the remainder being water;
an emulsion consisting of: 50% by weight of di-sec-butyl peroxydicarbonate, 1.5% by weight of ethoxylated castor oil with a mean degree of ethoxylation of 20, 21.4% by weight of propane-1,2-diol and 11.5% of 3-hydroxy-1,1-dimethylbutyl peroxyneodecanoate, the remainder being water.

The invention also relates to a process for preparing an emulsion as described above, comprising a step of mixing the at least one organic peroxide, the at least one emulsifier, the at least one antifreeze and water; and optionally, a step of emulsifying the mixture.

The invention also relates to the use of an emulsion as described above for the polymerization or copolymerization of one or more ethylenically unsaturated monomers, in particular vinyl monomers, preferably halogenated vinyl monomers, and more preferentially vinyl chloride.

The invention also relates to a halogenated vinyl polymer obtained by polymerization of at least one ethylenically unsaturated monomer in the presence of an emulsion as described above.

The present invention makes it possible to meet the need expressed above. It more particularly provides a homogeneous organic peroxide emulsion that is stable over time, in which the mean and maximum droplet sizes remain as small as possible, thus enabling it to be safely transported and stored over long periods, and meeting the required conditions in terms of emulsion viscosity and flow time. In addition, the emulsion according to the invention allows the production of a polymer, when it used for the polymerization of ethylenically unsaturated monomers, having a low content of hard grains.

Surprisingly, it was found that emulsions having low contents (or even being free) of ethanol, methanol and protective colloidal agent, in combination with the use of an emulsifier and a particular antifreeze, allows the production of small droplets which remain stable and homogeneous over a long period of time, with a suitable viscosity.

### DETAILED DESCRIPTION

The invention is now described in greater detail and in a nonlimiting manner in the description that follows.

In the present text, unless expressly indicated otherwise, all the percentages (%) shown are weight percentages relative to the total weight of the emulsion.

In the present text, the amounts indicated for a given species may apply to that species according to all its definitions (as mentioned in the present text), including the more restricted definitions.

### Emulsion

The invention relates firstly to an organic peroxide emulsion. The emulsion according to the invention is an aqueous emulsion, i.e. it comprises water. Preferably, the water is demineralized or deionized water.

Particularly preferably, the emulsion is an oil-in-water type emulsion.

The emulsion according to the invention comprises at least one organic peroxide.

The organic peroxide is preferably chosen from peroxydicarbonates, peroxyesters, and/or diacyl peroxides.

Among the peroxydicarbonates, the preferred peroxides are diethyl peroxydicarbonate, diisopropyl peroxydicarbonate, di-n-propyl peroxydicarbonate, di-sec-butyl peroxydicarbonate, di-n-butyl peroxydicarbonate, diisobutyl peroxydicarbonate, di-tert-butyl peroxydicarbonate, bis(3-methoxybutyl) peroxydicarbonate, dineopentyl peroxydicarbonate, bis[2-(2-methoxyethoxy)ethyl] peroxydicarbonate, bis(3-methoxy-3-methylbutyl) peroxydicarbonate, bis(2-ethoxyethyl) peroxydicarbonate, bis(2-ethylhexyl) peroxydicarbonate, and mixtures thereof. Among the peroxyesters, the preferred peroxides are tert-amyl peroxypivalate, tert-butyl peroxypivalate, tert-butyl peroxyneodecanoate, tert-amyl peroxyneodecanoate, tert-butyl peroxyisobutyrate, cumyl peroxyneodecanoate, cumyl peroxyneoheptanoate, 2,4,4-trimethylpentyl peroxyneodecanoate, tert-butyl peroxy-n-heptanoate, cumyl peroxy-n-heptanoate, tert-amyl peroxy-n-heptanoate, tert-butyl peroxy-n-octanoate, tert-amyl peroxy-n-octanoate, tert-butyl peroxyneoheptanoate, tert-amyl peroxy-2-ethylhexanoate, tert-butyl peroxy-2-ethylhexanoate, 1,1,3,3-tetramethylbutyl peroxy-2-ethylhexanoate, hydroxyperoxy esters and mixtures thereof.

As hydroxyperoxyesters that may be used in the emulsion according to the invention, mention may be made of 4-hydroxy-2-methylpentyl peroxyneodecanoate, 4-hydroxy-2-methylpentyl peroxy(2-ethylhexanoate), 4-hydroxy-2-methylpentyl peroxy-2-phenylbutyrate, 4-hydroxy-2-methylpentyl peroxy-2-phenoxypropionate, 4-hydroxy-2-methylpentyl peroxy(2-butyloctanoate), 4-hydroxy-2-methylpentyl peroxyneotridecanoate, 4-hydroxy-2-methylhexyl peroxyneodecanoate, 5-hydroxy-1,3,3-trimethylcyclohexyl peroxyneodecanoate, 4-hydroxy-2,6-dimethyl-2,6-bis(neohexanoylperoxy)heptane, 4-hydroxy-2,6-dimethyl-2,6-bis(neodecanoylperoxy)heptane, 3-hydroxy-1,1-dimethylbutyl peroxy-2-ethylhexanoate, 3-hydroxy-1,1-dimethylbutyl peroxyneodecanoate and mixtures thereof.

Among the diacyl peroxides, the preferred peroxides are chosen from the group consisting of diisobutyryl peroxide, bis(2-ethylbutanoyl) peroxide, bis(3,5,5-trimethylhexanoyl) peroxide, bis(2-ethylhexanoyl) peroxide, and also asymmetric peroxides such as isobutyroyl octanoyl peroxide, isobutyroyl decanoyl peroxide, isobutyroyl lauroyl peroxide, 2-ethylbutanoyl decanoyl peroxide, 2-ethylhexanoyl lauroyl peroxide, and mixtures thereof.

Particularly preferably, the organic peroxide is chosen from the group consisting of tert-butyl peroxyneodecanoate, for example sold under the name Luperox® 10 by Arkema, 3-hydroxy-1,1-dimethylbutyl peroxyneodecanoate, for example sold under the trade name Luperox® 610 by Arkema, cumyl peroxyneodecanoate, for example sold under the name Luperox® 188 by Arkema, di-sec-butyl peroxydicarbonate, for example sold under the trade name Luperox® 225 by Arkema, bis(2-ethylhexyl) peroxydicarbonate, for example sold under the trade name Luperox® 223 by Arkema, tert-amyl peroxyneodecanoate, for example sold under the name Luperox® 546 by Arkema, tert-butyl peroxypivalate, for example sold under the name Luperox® 11 by Arkema, tert-amyl peroxypivalate, for example sold under the name Luperox® 554 by Arkema, bis(3,5,5-trimethylhexanoyl) peroxide, for example sold under the name Luperox® 219 by Arkema, and mixtures thereof. Preferably, said organic peroxide is bis(2-ethylhexyl) peroxydicarbonate.

The emulsion according to the invention may comprise a mixture of two or more organic peroxides, in particular as described above.

Alternatively, the emulsion according to the invention may comprise a single organic peroxide, in particular a single organic peroxide as described above.

In a particular embodiment, the emulsion according to the invention does not comprise any di-sec-butyl peroxydicarbonate.

Preferably, the emulsion according to the invention comprises the at least one organic peroxide in a content ranging from 40% to 80% by weight, preferably ranging from 44% to 65% by weight, more preferably ranging from 45% to 60% by weight, relative to the total weight of the emulsion.

Preferably, when the emulsion comprises several organic peroxides, their total content ranges from 40% to 80% by weight, preferably from 44% to 65% by weight, more preferably from 45% to 60% by weight, relative to the total weight of the emulsion.

The organic peroxide(s) according to the invention advantageously have a one-hour half-life temperature, measured in trichloroethylene, of less than or equal to 90° C., preferably less than 80° C.

Furthermore, the organic peroxide(s) in the emulsion according to the invention advantageously have a storage temperature below 0° C.

The organic peroxide(s) are advantageously liquid at the storage temperature, preferably at a storage temperature below 0° C., measured at atmospheric pressure.

The emulsion according to the invention comprises at least one antifreeze. The antifreeze prevents the formation of gels when the emulsion is transported and/or stored cold, i.e. conventionally in an environment with temperatures below 0° C.

The antifreeze according to the invention has a dynamic viscosity at 20° C. ranging from 40 to 100 mPa·s. The dynamic viscosity of the antifreeze at 20° C. may be measured in accordance with the standard DIN 53019 using a device such as a Haake VT550 Viscotester, at a shear rate of 100 s⁻¹. The use of an antifreeze with such a dynamic viscosity allows the production of emulsions with a viscosity low enough to be compatible with polymerization applications. Preferably, the at least one antifreeze included in the emulsion according to the invention consists of at least one antifreeze with a dynamic viscosity at 20° C. ranging from 40 to 100 mPa·s.

The dynamic viscosity at 20° C. of the antifreeze is more preferentially less than or equal to 90 mPa·s, preferably less than or equal to 80 mPa·s, preferably less than or equal to 70 mPa·s, preferably less than or equal to 60 mPa·s and more preferentially 55 mPa·s.

The antifreeze according to the invention has a dynamic viscosity at 20° C. of greater than or equal to 40 mPa·s. The use of an antifreeze with such a dynamic viscosity makes it possible to limit the mobility of the emulsion droplets and thus to increase the stability of the emulsion. It also allows the production of droplets with a smaller mean size.

In particular, the antifreeze may have a dynamic viscosity at 20° C. of from 40 to 55 mPa·s.

The antifreeze is preferably an alcohol. Thus, the antifreeze may be any alcohol that is water-soluble at the storage temperature, for example at a temperature of 0° C., complying with the dynamic viscosity conditions mentioned above. The term “water-soluble alcohol” means a solubility of greater than 1% in water at 0° C. The amount of antifreeze in water may be measured by gas chromatography.

More particularly, the antifreeze may advantageously be a diol.

Preferably, the antifreeze is chosen from the group consisting of propane-1,2-diol (dynamic viscosity at 20° C. of 45 mPa·s), propane-1,3-diol (dynamic viscosity at 20° C. of 52 mPa·s) and triethylene glycol (dynamic viscosity at 20° C. of 48 mPa·s) and mixtures thereof, these mixtures comprising at least two of the antifreezes listed previously.

More preferentially, the antifreeze is propane-1,2-diol.

According to advantageous embodiments, the antifreeze is propane-1,2-diol, optionally as a mixture with one, or more, antifreezes, preferably as mentioned above. More advantageously, the antifreeze consists of propane-1,2-diol.

According to other advantageous embodiments, the antifreeze comprises a mixture of propane-1,2-diol and 2-propanol, optionally as a mixture with one, or more, antifreezes, preferably as mentioned above. More advantageously, the antifreeze consists of a mixture of propane-1,2-diol and 2-propanol. Relative to the use of propane-1,2-diol alone, the use of a mixture of propane-1,2-diol and 2-propanol makes it possible to reduce the viscosity of the emulsion. Relative to the use of 2-propanol alone, the use of a mixture of propane-1,2-diol and 2-propanol makes it possible to increase the stability of the emulsion.

The mass ratio of propane-1,2-diol relative to 2-propanol is preferably strictly greater than 1, preferably strictly greater than 1 and less than 4, preferably strictly greater than 1 and less than 2.

When the emulsion according to the invention comprises an alcohol chosen from the group consisting of methanol, ethanol, ethylene glycol and diethylene glycol, this alcohol is present in a mass ratio strictly less than 1, preferably less than 0.9, more preferentially less than 0.7 and more preferentially less than 0.5 relative to said at least one antifreeze with a dynamic viscosity at 20° C. ranging from 40 mPa·s to 100 mPa·s.

In one embodiment, when the emulsion according to the invention comprises an alcohol with a dynamic viscosity at 20° C. strictly less than 40 mPa·s or strictly greater than 100 mPa·s, this alcohol is present in a mass ratio strictly less than 1, preferably less than 0.9, more preferentially less than 0.7 and more preferentially less than 0.5 relative to said at least one antifreeze with a dynamic viscosity at 20° C. ranging from 40 mPa·s to 100 mPa·s.

In particular, when the emulsion according to the invention comprises an alcohol other than propane-1,2-diol, propane-1,3-diol and triethylene glycol, said alcohol is present in a mass ratio strictly less than 1, preferably less than 0.9, more preferentially less than 0.7 and more preferentially less than 0.5, relative to said at least one antifreeze chosen from the group consisting of propane-1,2-diol, propane-1,3-diol and triethylene glycol.

When the emulsion comprises two or more antifreezes with a dynamic viscosity at 20° C. ranging from 40 mPa·s to 100 mPa·s, then the ratio is calculated relative to the total weight of said antifreezes.

Similarly, when the emulsion comprises two or more alcohols chosen from the group consisting of methanol, ethanol, ethylene glycol and diethylene glycol, then the ratio is calculated relative to the total weight of said alcohols.

Similarly, when the emulsion comprises two or more alcohols with a dynamic viscosity at 20° C. strictly less than 40 mPa·s or strictly greater than 100 mPa·s, then the ratio is calculated relative to the total weight of said alcohols.

Preferably, the emulsion according to the invention comprises less than 5% by weight, preferably less than 2% by weight, more preferentially less than 1% by weight, more preferentially less than 0.4% by weight and more preferentially is free of ethanol.

Preferably, the emulsion according to the invention comprises less than 5% by weight, preferably less than 2% by weight, more preferentially less than 1% by weight, more preferentially less than 0.4% by weight and more preferentially is free of methanol.

In a particularly preferred embodiment, the emulsion according to the invention is free of methanol and ethanol.

Preferably, the emulsion according to the invention comprises less than 5% by weight, preferably less than 2% by weight, more preferentially less than 1% by weight, and more preferentially is free of ethylene glycol.

Preferably, the emulsion according to the invention comprises less than 5% by weight, preferably less than 2% by weight, more preferentially less than 1% by weight, and more preferentially is free of diethylene glycol.

Preferably, the at least one antifreeze in the emulsion according to the invention consists of one or more antifreezes as defined above; particularly preferably, the antifreeze consists of propane-1,2-diol.

The antifreeze is preferably present in the emulsion according to the invention in a content of less than or equal to 40% by weight (relative to the total weight of the emulsion), preferably less than or equal to 25% by weight, more preferably less than or equal to 22% by weight, relative to the total weight of the emulsion. Such antifreeze contents allow the aqueous phase to remain in liquid form down to temperatures of less than or equal to −20° C., preferably down to temperatures of less than or equal to −25° C. Thus, a person skilled in the art is capable of determining the amount of antifreeze required to keep the aqueous phase in liquid form at the storage temperature.

More particularly, the antifreeze may be present in the emulsion in an amount of from 10% to 40% by weight, preferably from 15% to 25% by weight, more preferably from 17% to 22% by weight, relative to the total weight of the emulsion.

Preferably, the amount of antifreeze present in the emulsion comprises both the amount of antifreeze according to the invention and the amount of any other antifreezes present in the emulsion.

The emulsion according to the invention comprises at least one emulsifier.

Preferably, the emulsifier according to the invention is readily biodegradable. The qualification of the biodegradability of the emulsifier may be determined by the OECD 301 method and more particularly by the OECD 301 B method by release of carbon dioxide.

The emulsifier comprises, or is (i.e. consists of), one or more nonionic surfactants comprising at least one fatty chain and having an HLB of less than or equal to 18.

The term “fatty chain” means an aliphatic carbon-based chain optionally comprising hydroxyl branches and at least 6 carbon atoms, preferably from 6 to 60 carbon atoms, more preferentially from 6 to 20 carbon atoms. The nonionic surfactant may or may not be oxyalkylenated.

Preferably, the nonionic surfactant comprises, or is, an oxyalkylenated or non-oxyalkylenated nonionic surfactant chosen from the group consisting of fatty alcohols, fatty acids, sorbitan esters, alkyl glucosides, plant or animal oils (hydrogenated or non-hydrogenated) and mixtures thereof. The nonionic surfactant mixtures used in the invention may be mixtures of oxyalkylenated nonionic surfactants only, or mixtures of non-oxyalkylenated nonionic surfactants only, or mixtures of oxyalkylenated nonionic surfactants and non-oxyalkylenated nonionic surfactants.

Advantageously, the nonionic surfactant comprises, or is, a nonionic surfactant chosen from the group consisting of oxyalkylenated fatty alcohols, oxyalkylenated fatty acids, oxyalkylenated plant or animal oils, polysorbates, sorbitan esters, non-oxyalkylenated alkyl glucosides, oxyalkylenated alkyl glucosides, and mixtures thereof.

The oxyalkylene units are more particularly oxyethylene units (i.e. ethylene oxide groups), oxypropylene units (i.e. propylene oxide groups), or a combination of oxyethylene units and oxypropylene units; preferably, the oxyalkylene units are oxyethylene units or a combination of oxyethylene units and oxypropylene units.

Thus, the nonionic surfactant is preferably chosen from the group consisting of fatty alcohols containing oxyethylene units and optionally oxypropylene units, fatty acids containing oxyethylene units and optionally oxypropylene units, plant or animal oils, which are optionally hydrogenated, containing oxyethylene units and optionally oxypropylene units, polysorbates, sorbitan esters, alkyl glucosides containing oxyethylene units and optionally oxypropylene units, and mixtures thereof.

The oxyethylene units (i.e. ethylene oxide groups) and oxypropylene units (i.e. propylene oxide groups) may be distributed randomly or in block form.

The number of moles of ethylene oxide and/or propylene oxide preferably ranges from 1 to 250, more preferentially from 2 to 100, even more preferentially from 2 to 50 and more particularly from 2 to 40.

Preferably, the number of moles of ethylene oxide in the emulsifier ranges from 2 to 40.

For the purposes of the present invention, the term “fatty alcohol” means an alcohol containing at least 6 and preferably at least 8 carbon atoms, more preferably a C₈-C₄₀ alcohol, preferentially a C₈-C₂₀ alcohol.

Among the fatty alcohols that may be used in the invention, mention may notably be made of 2-octyldodecanol, decanol, lauryl alcohol, oleocetyl alcohol, isodecanol, capryl alcohol, oxoisotridecanol, cetostearyl alcohol, eleostearyl alcohol, caprylyl alcohol, myristyl alcohol, hexadecyl or palmityl alcohol, stearyl alcohol, eicosanyl or arachidyl alcohol, behenyl alcohol, oleyl alcohol, eicosenyl or gadoleyl alcohol, docosenyl alcohol, ricinoleyl alcohol, linoleyl alcohol, linolenyl alcohol or mixtures thereof.

Preferably, the nonionic surfactant is chosen from the group consisting of oxyalkylenated fatty alcohols and is preferably chosen from octyldodecanol, decanol, lauryl alcohol, oleocetyl alcohol, isodecanol, capryl alcohol, oxoisotridecanol, cetostearyl alcohol, eleostearyl alcohol, caprylyl alcohol, myristyl alcohol, hexadecyl or palmityl alcohol, stearyl alcohol, eicosanyl or arachidyl alcohol, behenyl alcohol, oleyl alcohol, eicosenyl or gadoleyl alcohol, docosenyl alcohol, ricinoleyl alcohol, linoleyl alcohol or linolenyl alcohol, which are oxyalkylenated, preferably oxyethylenated and/or oxypropylenated, and more preferentially oxyethylenated and optionally oxypropylenated.

The fatty alcohols that are more preferred in the context of the invention are oleocetyl alcohol, hexadecyl or palmityl alcohol, stearyl alcohol, oleyl alcohol, linoleyl alcohol or mixtures thereof, and even more preferred are the oxyalkylenated, preferably oxyethylenated and/or oxypropylenated, and more preferentially oxyethylenated and optionally oxypropylenated versions thereof.

More preferably, the nonionic surfactant is an oxyalkylenated fatty alcohol chosen from the group consisting of oxyethylenated linoleyl alcohol, oxyethylenated oleocetyl alcohol, oxyethylenated hexadecyl or palmityl alcohol, oxyethylenated stearyl alcohol, oxyethylenated oleyl alcohol, and mixtures thereof.

The fatty alcohols mentioned previously may optionally be oxypropylenated to a minor extent.

Preferably, the oxyalkylenated plant/animal oils (hydrogenated or non-hydrogenated) are in particular derivatives of ethoxylated mono-, di- and triglycerides and comprise a complex mixture of ethoxylated glycerol optionally linked to one or more fatty acid chains (which are themselves ethoxylated or not), fatty acids ethoxylated on the acid function and/or on the hydroxyl function borne by the fatty acid chain, and also variable proportions of fatty acids, glycerol and fatty acid mono-, di- or triglycerides.

For the purposes of the present invention, the term “fatty acid” means an acid or a mixture of acids comprising at least 6 carbon atoms, preferably from 6 to 40 carbon atoms, more preferentially from 8 to 20 carbon atoms.

The oxyalkylenated plant/animal oils (hydrogenated or non-hydrogenated) that may be used in the invention are preferably chosen from the group consisting of optionally hydrogenated, oxyethylenated (or ethoxylated) plant oils.

The optionally hydrogenated, oxyethylenated plant oils are preferably chosen from the group consisting of ethoxylated castor oil and ethoxylated hydrogenated castor oil comprising from 5 to 40 mol of ethylene oxide per mole of ricinoleic acid. Mention may also be made of ethoxylated oils derived from coconut kernel oil, palm oil, palm kernel oil, olive oil, groundnut oil, rapeseed oil, soybean oil, sunflower oil, walnut oil, hazelnut oil, coconut oil, poppy oil, safflower oil, linseed oil, perilla oil, oitica oil, and/or Chinese wood oil. As plant/animal oils that may be used according to the invention as emulsifiers, mention may also be made of ethoxylated fats based on tallow oil, crude or refined tall oil, whale oil, herring oil and/or sardine oil. All these ethoxylated glyceride derivatives are characterized in that they include mixtures of ethoxylated mono-, di- or triglycerides and also corresponding ethoxylated derivatives of fatty acids and of glycerol. These fatty acids are notably saturated or unsaturated fatty acids derived from caproic acid, caprylic acid, capric acid, lauric acid, myristic acid, palmitic acid, stearic acid, arachic acid, behenic acid, myristoleic acid, palmitoleic acid, oleic acid, ricinoleic acid, erucic acid, linoleic acid, linolenic acid, eleostearic acid, licanic acid, gadoleic acid, and/or erneic acid. Some unsaturated fatty acids may or may not be hydrogenated as in the case of ethoxylated castor oil in which the ricinoleic group may or may not have been partially or fully hydrogenated.

In certain embodiments, the nonionic surfactant according to the invention may comprise, or be, one or more fatty acids, which are preferably oxyalkylenated, more preferably and optionally oxyethylenated oxypropylenated, these fatty acids possibly being chosen from those listed above.

Advantageously, the nonionic surfactant may comprise, or be, a nonionic surfactant chosen from the group consisting of oxyalkylenated plant or animal oils (hydrogenated or non-hydrogenated).

More preferentially, the nonionic surfactant may comprise, or be, a nonionic surfactant chosen from the group consisting of plant oils, which are optionally hydrogenated, oxyethylenated and optionally oxypropylenated.

More preferentially, the nonionic surfactant may comprise, or be, a nonionic surfactant chosen from the group consisting of ethoxylated, optionally hydrogenated plant oils including from 5 to 40 mol of ethylene oxide, in particular ethoxylated castor oil and ethoxylated hydrogenated castor oil including from 20 to 40 mol of ethylene oxide.

Even more preferentially, the nonionic surfactant may comprise, or be, ethoxylated castor oil including from 20 to 40 mol of ethylene oxide.

Advantageously, the nonionic surfactant may comprise, or be, one or more non-ethoxylated sorbitan esters and/or one or more ethoxylated sorbitan esters. In the present text, ethoxylated sorbitan esters are also referred to as “polysorbates”, the term “sorbitan ester” denoting in the present text non-ethoxylated sorbitan esters, unless expressly indicated otherwise.

Preferably, the non-ethoxylated sorbitan ester is chosen from the group consisting of sorbitan monostearate, sorbitan tristearate, sorbitan monolaurate, sorbitan trilaurate, sorbitan monooleate, sorbitan trioleate, sorbitan monopalmitate and sorbitan tripalmitate and combinations thereof.

Sorbitan monooleate is available under the brand name Span 80® (from Croda).

Preferably, the ethoxylated sorbitan ester (or polysorbate) comprises between 3 and 40 ethylene oxide groups, preferably between 5 and 20 ethylene oxide groups.

Preferably, the ethoxylated sorbitan ester is chosen from the group consisting of ethoxylated sorbitan monostearate, ethoxylated sorbitan tristearate, ethoxylated sorbitan monolaurate, ethoxylated sorbitan trilaurate, ethoxylated sorbitan monooleate, ethoxylated sorbitan trioleate, ethoxylated sorbitan monopalmitate, ethoxylated sorbitan tripalmitate and combinations thereof.

Sorbitan monooleate 20 OE (i.e. with an average of 20 ethylene oxide groups) is available under the brand name Surfaline SE80® (from Arkema) or Tween 80® (from Croda).

The nonionic surfactant may comprise, or be, one or more alkyl glucosides. As alkyl glucosides that may be used in the invention, mention may be made of capryl glucoside, caprylyl glucoside, lauryl glucoside, cocoyl glucoside, hexyl glucoside, isooctyl glucoside, decyl glucoside and/or undecyl glucoside. These alkyl glucosides may or may not be oxyalkylenated (and more particularly ethoxylated or non-ethoxylated).

The emulsion may comprise a combination of at least two nonionic surfactants, in particular each of which may independently be as described above.

Preferably, the combination of the at least two nonionic surfactants comprises a non-ethoxylated sorbitan as defined above and an ethoxylated sorbitan comprising between 5 and 20 ethylene oxide groups, as described above.

The nonionic surfactant may advantageously have a molar mass of less than or equal to 10 000 g/mol. More preferably, the molar mass of the nonionic surfactant is less than or equal to 5000 g/mol, even more preferentially less than or equal to 2000 g/mol. The likelihood of the nonionic surfactant having good biodegradability is higher when its molar mass is within the ranges below. Preferably, the at least one emulsifier of the emulsion according to the invention consists of at least one nonionic surfactant comprising at least one fatty chain, having an HLB of less than or equal to 18 and having a molar mass in the abovementioned ranges.

The nonionic surfactant according to the invention has an HLB (Hydrophilic-Lipophilic Balance) of less than or equal to 18, preferably less than or equal to 17, more preferentially less than or equal to 16.5, and more preferably less than or equal to 16.2. In certain embodiments, the nonionic surfactant (when the emulsifier comprises a single nonionic surfactant) or the mixture of nonionic surfactants (when the emulsifier comprises several nonionic surfactants) has an HLB of less than or equal to 15.5, preferably less than or equal to 15.

The term “HLB” or “HLB value” means the hydrophilic-lipophilic balance which enables assessment of the solubility of an emulsifier in water. Preferably, the HLB is determined according to the method proposed by Griffin (Journal of the Society of Cosmetic Chemists, 5(4), (1954), 249-256). The HLB of a combination of at least two emulsifiers may be calculated from the mass ratio of said emulsifiers.

The emulsifier may be present in the emulsion according to the invention in an amount ranging from 0.1% to 10% by weight, preferably from 0.2% to 5% by weight, preferably from 0.5% to 2.5% by weight, more preferentially from 0.6% to 2% by weight and more preferentially strictly greater than 1% and strictly less than 2% by weight relative to the total weight of the emulsion. The nonionic surfactant as described above may also be present in the emulsion in the amounts mentioned above.

The emulsion according to the invention may also comprise one or more additives intended the to give final composition particular properties/characteristics. These additives will ideally be present for the final polymerization or copolymerization.

The additive may be chosen from the group consisting of antifoams, chain-transfer agents, chain extenders, pH regulators, plasticizers and mixtures thereof.

The additive(s) are preferably present in an amount of from 0.1% to 10% by weight, preferably from 1% to 5% by weight, relative to the total weight of the emulsion.

Preferably, the emulsion according to the invention comprises one or more plasticizers, preferably chosen from the group consisting of aliphatic esters, for instance phthalates, adipates, benzoates, hydrogenated derivatives of these molecules and mixtures thereof. In particular, the plasticizer may be diisononylcyclohexane, diisononyl cyclohexanedicarboxylate, and a mixture thereof. The plasticizer(s) may be present in the emulsion in an amount of from 1% to 5% by weight relative to the total weight of the emulsion.

Preferably, the emulsion according to the invention comprises from 0 to 1% by weight, preferably from 0 to 0.5% by weight, more preferentially from 0 to 0.1% by weight of polyvinyl acetate, in particular partially hydrolyzed polyvinyl acetate, relative to the total weight of the emulsion. Preferably, the emulsion according to the invention is free of partially hydrolyzed polyvinyl acetate, in particular is free of polyvinyl acetate and more preferentially is free of protective colloidal agent.

For the purposes of the present invention, the term “protective colloidal agent” refers to the group consisting of polyvinyl alcohol, polyvinyl acetate and notably partially hydrolyzed polyvinyl acetate, cellulose esters and xanthan gums.

The absence of protective colloidal agent in the emulsion notably makes it possible to reduce the time for the industrial preparation of the emulsion, since the protective colloidal agent (notably polyvinyl acetate) which is in solid form requires a prior dissolution step, and makes it possible to minimize the risks associated with the handling of powders. In addition, the presence in the emulsion of a protective colloidal agent may increase the viscosity of the emulsion, which may be undesirable for certain applications.

Preferably, the emulsion according to the invention comprises from 0 to 2% by weight of chlorinated paraffin, preferably from 0 to 1% by weight, and more preferentially the emulsion according to the invention is free of chlorinated paraffin. The low content, or even the absence, of chlorinated paraffin makes it possible, when the emulsion is used for the polymerization of ethylenically unsaturated monomers, to produce a more environmentally-friendly polymer.

Preferably, the emulsion according to the invention comprises from 0 to 0.05% by weight, and preferably does not contain any copolymers of α-olefins and of dicarboxylic acids, partially esterified with an ethoxylated alcohol, such as Dapral® GE202, also known as Ketjenlube® 522. In a particular embodiment, the emulsion according to the invention does not comprise any lubricant. For the purposes of the present invention, the term “lubricant” means a substance interposed between two surfaces that are in relative motion so as to reduce the friction therebetween.

Advantageously, the emulsion according to the invention may consist essentially of, or consist of, at least one organic peroxide, at least one emulsifier, at least one antifreeze, water and optionally one or more additives as described above, said emulsion preferably not being one of the compositions excluded above. The term “the emulsion consists essentially of constituents” means that the total amount of these constituents represents at least 90% by weight, preferably at least 95% by weight, more preferentially at least 98% by weight relative to the total weight of the emulsion. The expression “consists of” does not exclude the presence of impurities present in trace amounts in the emulsion (for example, in an amount of less than or equal to 1% by weight relative to the total weight of the emulsion), for example impurities introduced with the organic peroxide. Thus, in certain embodiments, the emulsion according to the invention may comprise an organic solvent, in an amount of less than or equal to 1% by weight relative to the total weight of the emulsion.

The emulsion according to the invention may comprise an organic solvent, preferably a non-chlorinated organic solvent, for example in an amount of less than or equal to 20% by weight relative to the total weight of the emulsion. In the present text, the term “organic solvent” means organic solvents which have a solubility in water of less than 1% by weight at 0° C. The emulsion according to the invention may consist essentially of, or consist of, the at least one organic peroxide, the at least one emulsifier, the at least one antifreeze, water, a non-chlorinated organic solvent (preferably in an amount of less than or equal to 20% by weight relative to the total weight of the emulsion) and optionally one or more additives as described above.

The emulsion according to the invention may consist essentially of, or consist of, the at least one organic peroxide, the at least one emulsifier, the at least one antifreeze and water (the emulsion preferably being free of methanol, ethanol and polyvinyl alcohol).

Preferably, the emulsion according to the invention has a flowability (or flow time) at 5° C., measured via a consistometric cup technique, of less than or equal to 200 seconds, more preferentially less than or equal to 170 seconds, and even more advantageously less than or equal to 100 seconds. The flowability may be measured according to the standard DIN 53211, with a viscosity cup diameter of 4 mm and a temperature of 5° C.

Particularly advantageously, the emulsion according to the invention has a mean droplet size of less than or equal to 10 μm, preferably less than or equal to 4 μm. Advantageously, the emulsion according to the invention has a maximum droplet size of less than or equal to 20 μm, more preferentially less than or equal to 15 μm. The droplet size (mean and maximum) may be determined via conventional means using the light scattering technique. The measurements may be taken using a Malvern MasterSizer 2000® device at room temperature.

More advantageously, the emulsion according to the invention has the abovementioned droplet sizes during the storage period, for example for a period of at least six months.

Preferably, the concentration of organic peroxide in the emulsion is homogeneous. The term “homogeneous concentration” means that the difference between the concentrations of peroxide (as mass percentages) at the top and bottom of the emulsion is less than 3%, preferably less than 2%. The organic peroxide concentration is measured by HPLC on one sample taken from the top of the emulsion and another from the bottom of the emulsion.

More advantageously, the emulsion according to the invention is homogeneous during the storage period, for example for a period of at least six months.

Another subject of the invention is an organic peroxide emulsion comprising (or consisting essentially of, or consisting of):
at least one organic peroxide;
at least one emulsifier comprising at least one nonionic surfactant comprising at least one fatty chain and having an HLB of less than or equal to 18;
at least one antifreeze chosen from the group consisting of propane-1,2-diol, propane-1,3-diol, triethylene glycol and mixtures thereof;
water;
optionally one or more additives chosen from the group consisting of antifoams, chain-transfer agents, chain extenders, pH regulators, plasticizers and mixtures thereof;
optionally an organic solvent; and
when said emulsion comprises at least one alcohol chosen from the group consisting of methanol, ethanol, ethylene glycol and diethylene glycol, said alcohol is present in a mass ratio strictly less than 1 relative to said at least one antifreeze with a dynamic viscosity at 20° C. ranging from 40 mPa·s to 100 mPa·s;
   preferably, said emulsion not being one of the compositions excluded above.

According to another aspect, the invention relates to an emulsion comprising (or consisting essentially of, or consisting of):
at least one organic peroxide;
at least one emulsifier comprising a nonionic surfactant with a molar mass of less than or equal to 10 000 g/mol or a combination of two or more nonionic surfactants with a molar mass of less than or equal to 10 000 g/mol, in which the nonionic surfactant or the combination of nonionic surfactants have an HLB of less than or equal to 15;
at least one antifreeze with a dynamic viscosity at 20° C. ranging from 40 mPa·s to 100 mPa·s;
water;
optionally one or more additives chosen from the group consisting of antifoams, chain-transfer agents, chain extenders, pH regulators, plasticizers and mixtures thereof; and
optionally an organic solvent;
   when said emulsion comprises at least one alcohol chosen from the group consisting of methanol, ethanol, ethylene glycol and diethylene glycol, said alcohol is present in a mass ratio strictly less than 1 relative to said at least one antifreeze with a dynamic viscosity at 20° C. ranging from 40 mPa·s to 100 mPa·s;
preferably, said emulsion not being one of the compositions excluded above. The at least one emulsifier may consist of a nonionic surfactant with a molar mass of less than or equal to 10 000 g/mol or a combination of two or more nonionic surfactants each having a molar mass of less than or equal to 10 000 g/mol, the nonionic surfactant or the combination of nonionic surfactants having an HLB of less than or equal to 15.

According to this aspect, the invention provides a homogeneous organic peroxide emulsion which is stable over time and which has mean and maximum droplet sizes which remain small. In addition, the emulsion has a sufficiently low viscosity and flow time and leads, when it used for the polymerization of ethylenically unsaturated monomers, to a polymer having a low content of hard grains. This is achieved by combining a particular emulsifier (comprising one or more nonionic surfactants with a specific molar mass and HLB) and a particular antifreeze (with a specific dynamic viscosity at 20° C.).

According to this aspect, the organic peroxide, emulsifier, antifreeze, water, additives, and the amounts thereof, may be as described above (unless expressly mentioned otherwise). The organic solvent may be present in an amount of less than or equal to 20% by weight relative to the total weight of the emulsion. The flowability at 5° C., droplet size and homogeneity of the emulsion may also be as described above. According to this second aspect, the emulsion may comprise a chlorinated solvent.

Yet another subject of the invention is an emulsion comprising (or consisting essentially of, or consisting of):
at least one organic peroxide;
at least one emulsifier comprising a nonionic surfactant with a molar mass of less than or equal to 10 000 g/mol or a combination of two or more nonionic surfactants with a molar mass of less than or equal to 10 000 g/mol, in which the nonionic surfactant or the combination of nonionic surfactants have an HLB of less than or equal to 15;
at least one antifreeze chosen from the group consisting of propane-1,2-diol, propane-1,3-diol, triethylene glycol and mixtures thereof;
water;
optionally one or more additives chosen from the group consisting of antifoams, chain-transfer agents, chain extenders, pH regulators, plasticizers and mixtures thereof; and
optionally an organic solvent;
when said emulsion comprises at least one alcohol chosen from the group consisting of methanol, ethanol, ethylene glycol and diethylene glycol, said alcohol is present in a mass ratio strictly less than 1 relative to said at least one antifreeze with a dynamic viscosity at 20° C. ranging from 40 mPa·s to 100 mPa·s;
preferably, said emulsion not being one of the compositions excluded above. The organic peroxide, emulsifier, antifreeze, water, additives, and the amounts thereof, may be as described above (unless expressly mentioned otherwise). The features of the emulsion may be as described above.

Preferably, the emulsion as defined above is not:
a composition consisting of 50% by weight of di-sec-butyl peroxydicarbonate, 1.44% by weight of ethoxylated castor oil with a mean degree of ethoxylation of 31 and 21.4% by weight of propane-1,2-diol, the remainder being water;
a composition consisting of 50% by weight of di-sec-butyl peroxydicarbonate, 1.5% by weight of ethoxylated castor oil with a mean degree of ethoxylation of 20 and 21.4% by weight of propane-1,2-diol, the remainder being water;
a composition consisting of 50% by weight of di-sec-butyl peroxydicarbonate, 1.5% by weight of ethoxylated castor oil with a mean degree of ethoxylation of 20, 21.4% by weight of propane-1,2-diol and 3% of 3-hydroxy-1,1-dimethylbutyl peroxyneodecanoate, the remainder being water;
a composition consisting of 50% by weight of di-sec-butyl peroxydicarbonate, 1.5% by weight of ethoxylated castor oil with a mean degree of ethoxylation of 20, 21.4% by weight of propane-1,2-diol and 11.5% of 3-hydroxy-1,1-dimethylbutyl peroxyneodecanoate, the remainder being water.

Preferably, in addition to the four compositions listed above, the emulsion as defined above is not either:
an emulsion comprising 59.9% by weight of bis(2-ethylhexyl) peroxydicarbonate, 20.6% by weight of propane-1,2-diol and 0.6% by weight of polyvinyl acetate with a degree of hydrolysis of 72.5 mol %, 0.30% by weight of ethoxylated C₁₆-C₁₈ alcohol comprising a mean degree of ethoxylation of 25, the remainder being water;
an emulsion consisting of 50.1% by weight of di-sec-butyl peroxydicarbonate, 1.6% by weight of nonionic surfactant, unsaturated C₁₆-C₁₈ glycerol mono/di-ester comprising a mean degree of ethoxylation of 15 units and 21.4% by weight of propane-1,2-diol, the remainder being water.

Preferably, the emulsion as defined above is not:
an emulsion consisting of 50% by weight of di-sec-butyl peroxydicarbonate, 1.44% by weight of ethoxylated castor oil and 21.4% by weight of propane-1,2-diol, the remainder being water;
an emulsion consisting of 50% by weight of di-sec-butyl peroxydicarbonate, 1.5% by weight of ethoxylated castor oil and 21.4% by weight of propane-1,2-diol, the remainder being water;
an emulsion consisting of 50% by weight of di-sec-butyl peroxydicarbonate, 1.5% by weight of ethoxylated castor oil, 21.4% by weight of propane-1,2-diol and 3% by weight of 3-hydroxy-1,1-dimethylbutyl peroxyneodecanoate, the remainder being water;
an emulsion consisting of 50% by weight of di-sec-butyl peroxydicarbonate, 1.5% by weight of ethoxylated castor oil, 21.4% by weight of propane-1,2-diol and 11.5% by weight of 3-hydroxy-1,1-dimethylbutyl peroxyneodecanoate, the remainder being water.

Preferably, in addition to the four emulsions listed above, the emulsion as defined above is not either:
an emulsion consisting of 59.9% by weight of bis(2-ethylhexyl) peroxydicarbonate, 20.6% by weight of propane-1,2-diol and 0.6% by weight of polyvinyl acetate, 0.30% by weight of C₁₆-C₁₈ alcohol, the remainder being water;
an emulsion consisting of 50.1% by weight of di-sec-butyl peroxydicarbonate, 1.6% by weight of C₁₆-C₁₈ glycerol mono/di-ester nonionic surfactant and 21.4% by weight of propane-1,2-diol, the remainder being water.

Even more preferably, the emulsion as defined above is not:
an emulsion comprising 49% to 51% by weight of di-sec-butyl peroxydicarbonate, 1.4% to 1.5% by weight of ethoxylated castor oil and 21% to 22% by weight of propane-1,2-diol;
an emulsion comprising 49% to 51% by weight of di-sec-butyl peroxydicarbonate, 1.4% to 1.6% by weight of ethoxylated castor oil and 21% to 22% by weight of propane-1,2-diol;
an emulsion comprising 49% to 51% by weight of di-sec-butyl peroxydicarbonate, 1.4% to 1.6% by weight of ethoxylated castor oil, 21% to 22% by weight of propane-1,2-diol and 2% to 4% by weight of 3-hydroxy-1,1-dimethylbutyl peroxyneodecanoate;
an emulsion comprising 49% to 51% by weight of di-sec-butyl peroxydicarbonate, 1.4% to 1.6% by weight of ethoxylated castor oil, 21% to 22% by weight of propane-1,2-diol and 11% to 12% by weight of 3-hydroxy-1,1-dimethylbutyl peroxyneodecanoate.

Preferably, in addition to the four emulsions listed above, the emulsion as defined above is not either:
an emulsion comprising 59% to 61% by weight of bis(2-ethylhexyl) peroxydicarbonate, 20% to 21% by weight of propane-1,2-diol and 0.4% to 0.8% by weight of polyvinyl acetate, 0.2% to 0.4% by weight of C₁₆-C₁₈ alcohol;
an emulsion comprising 49% to 51% by weight of di-sec-butyl peroxydicarbonate, 1% to 2% by weight of nonionic surfactant, C₁₆-C₁₈ and C₁₈ glycerol mono/di-ester and 21% to 22% by weight of propane-1,2-diol.

### Preparation of the Emulsion

The invention also relates to a process for preparing the emulsion according to the invention.

The preparation process according to the invention comprises a step of mixing the at least one organic peroxide, the at least one emulsifier, the at least one antifreeze and water, as defined above. This step may also comprise the above mixing with other constituents of the emulsion when the emulsion includes them, for example mixing with one or more additives (such as one or more plasticizers, etc.) as described in the preceding section. The mixing may be performed in one step (the constituents all being added to the mixture simultaneously) or in several steps (a premix of some constituents first being made, followed by the addition of other constituents).

The process may also comprise a step of emulsifying the mixture. The steps of mixing of the constituents of the emulsion and of emulsifying may be simultaneous. Alternatively, the emulsifying step may be performed successively to a first step of mixing the constituents of the emulsion.

The emulsion according to the invention may be prepared by dispersing at least the emulsifier and the antifreeze and also optionally one or more additives, in water to obtain a homogeneous aqueous phase, followed by adding one or more organic peroxides to said aqueous phase, the whole then being emulsified during an emulsion step. Alternatively, the emulsifier or one or more of the emulsifiers may be dissolved in the organic peroxide(s) before being added to the aqueous phase.

The abovementioned steps may be performed in the particular order indicated above, or in a different order.

The temperature at which the emulsion is prepared is not critical, but it must be sufficiently low to avoid a high rate of decomposition of the organic peroxide, which would result in a loss of titer. The temperature chosen depends on the organic peroxide.

Preferably, the mixing and/or emulsifying step are performed at a temperature below 5° C., and more preferably below −5° C. Mixing and emulsifying at such temperatures allows the premature degradation of the organic peroxide to be limited.

More preferentially, the mixing and/or emulsifying steps are performed at a temperature of between −15 and 10° C., preferably from −10 to 5° C. Preferably, the mixing and emulsifying steps are performed at the same temperature, preferably within the ranges mentioned above.

Deionized water or distilled water is preferably used to prepare the aqueous emulsion.

The emulsifying step of the process according to the invention is preferably performed with a high-shear mixer to optimally divide and/or homogenize the peroxide in the aqueous phase. Examples that may be mentioned include mechanically rotating blade and anchor stirrers, impeller stirrers, i.e. one or more stirrers mounted on a common shaft, turbine stirrers, i.e. those including baffles attached to the mixing vessel or adjacent to the stirrer members. Colloidal mills and homogenizers may also be used.

According to one variant of the process according to the invention, an ultrasonic mixer or a rotor-stator mixer may be used for the emulsification.

Following the preparation of the emulsion, the steps of pumping and introducing the emulsions into a polymerization reactor should generally be performed as quickly as possible. Accordingly, the peroxide emulsions should advantageously have a low viscosity. Thus, the organic peroxide emulsions according to the invention preferably have a dynamic viscosity range, at −10° C. and at a shear rate of 100 s⁻¹, of less than or equal to 850 mPa·s, more preferably less than or equal to 700 mPa·s, more preferentially less than or equal to 500 mPa·s, immediately after production (the viscosities are measured, for example, according to the standard DIN 53019 with a device such as a Haake VT550 Viscotester, at −10° C. and for a shear rate of 100 s⁻¹). Their flowability, measured by means of a consistometric cup technique, is advantageously less than or equal to 200 seconds, more preferentially less than or equal to 170 seconds, and even more advantageously less than or equal to 100 seconds (measured, for example, according to the standard DIN 53211, with a viscosity cup diameter of 4 mm and a temperature of 5° C.).

### Use

The present invention also relates to the use of an emulsion as described above for the polymerization or copolymerization of one or more ethylenically unsaturated monomers, in particular of one or more vinyl monomers, preferably halogenated vinyl monomers, and more preferentially vinyl chloride.

As examples of ethylenically unsaturated monomers that may be used in the invention, mention may be made of acrylates, vinyl esters, vinyl halide monomers, vinyl ethers, butadiene and/or aromatic vinyl compounds such as styrene.

Preferably, the ethylenically unsaturated monomers are chosen from the group consisting of vinyl halide monomers (i.e. halogenated vinyl monomers), and more preferentially the ethylenically unsaturated monomers are vinyl chloride.

The invention also relates to a process for preparing a halogenated vinyl polymer, comprising a step of polymerization or copolymerization of one or more ethylenically unsaturated monomers in the presence of an emulsion as described above. The ethylenically unsaturated monomers may be as described above and are more preferentially vinyl chloride. The halogenated vinyl polymer prepared is preferably a poly(vinyl chloride).

The polymerization of the ethylenically unsaturated monomer(s), preferably the polymerization of the vinyl chloride monomer, advantageously takes place in suspension, preferably at an initiation temperature ranging from 45° C. to 70° C.

The emulsion may be added directly to the polymerization reactor or may be premixed with other organic peroxides, water, polyvinyl alcohol and/or other additives prior to introducing this mixture into the polymerization reactor.

### Polymer

Another subject of the present invention relates to a halogenated vinyl polymer obtained (or which may be obtained) by polymerization of at least one ethylenically unsaturated monomer, as described above, in the presence of the emulsion according to the invention as described above. The polymerization may be as described in the preceding section.

Preferably, the invention relates to a poly(vinyl chloride) obtained (or which may be obtained) by polymerization of vinyl chloride in the presence of the emulsion according to the invention.

The invention also relates to a halogenated vinyl polymer obtained (or which may be obtained) via a preparation process as described above.

Such halogenated vinyl polymers have the advantage of having a low hard grain content. The hard grain content may be determined as described in the article by O. Leachs, in Kunststoffe, Vol. 50(4), 1960 pages 227-234.

### EXAMPLES

The following examples illustrate the invention without limiting it.

### Example 1

The following emulsions were prepared (the amounts indicated in the tables below are expressed as mass percentages relative to the total weight of the emulsion):

TABLE 1

| | Composition No. | | | | |
|---|---|---|---|---|---|
| | 1 | 2 | 3 | 4 | 5 |
| Span ® 80 | 0.8% | 0.8% | 0.8% | 0.8% | 0.8% |
| Tween ® 80 | 0.8% | 0.8% | 0.8% | 0.8% | 0.8% |
| Ethanol | | 13.5% | 9.9% | | |
| Propane-1,2-diol | 21.5% | 6.6% | 6.7% | 16.6% | 21.5% |
| Demineralized | qs 100 | qs 100 | qs 100 | qs 100 | qs 100 |
| water | | | | | |
| Luperox ® 10 | 50.0% | 50.0% | | | |
| Luperox ® 610 | | | 50.0% | 50.0% | 50.1% |

TABLE 2

| | Composition No. | | | |
|---|---|---|---|---|
| | 6 | 7 | 8 | 9 |
| Span ® 80 | | | 0.8% | 0.3% |
| Surfaline LG15 | | 1.6% | 1.5% | 1.6% |
| PVA | 1.2% | | | |
| Ethanol | | | 13.5% | |
| Propane-1,2-diol | 21.4% | 21.4% | 6.6% | 21.3% |
| Demineralized water | qs 100 | qs 100 | qs 100 | qs 100 |
| Luperox ® 225 | 50.1% | 50.1% | 50.1% | 50.1% |

qs 100 = quantity sufficient to reach 100% of the weight of the emulsion.

The nature of the compounds used is indicated below:
Luperox® 10: tert-butyl peroxyneodecanoate;
Luperox® 610: 3-hydroxy-1,1-dimethylbutyl peroxyneodecanoate;
Luperox® 225: di-sec-butyl peroxydicarbonate;
Span® 80: sorbitan monooleate nonionic surfactant (HLB: 4.3);
Tween® 80: polyethoxylated sorbitan monooleate nonionic surfactant (HLB: 15.0);
Surfaline LG15: nonionic surfactant, unsaturated C₁₆-C₁₈ and C₁₈ glycerol mono-/diester, polyethoxylated (15 units);
PVA: polyvinyl acetate with a degree of hydrolysis of 72.5 mol % (Alcotex 72.5).

Emulsions 1, 4, 5, 7 and 9 correspond to emulsions according to the invention, and emulsions 2, 3, 6 and 8 are comparative emulsions.

The emulsions were prepared as described below.

In the reactor, the aqueous phase containing the emulsifier(s) (with the exception of Span® 80), antifreeze and water was stirred at between 500 and 1000 revolutions per minute (rpm) with an impeller stirrer (IKA RW 20) fitted with an anchor rod, and maintained at −5° C. (Celsius) for 5 minutes. Span® 80 was added to the organic peroxide at −5° C. with stirring, and this mixture was stirred for 5 minutes.

The organic peroxides (with Span® 80 where appropriate) were gradually added to the reactor containing the aqueous phase. Stirring was continued for three minutes at 2000 rpm. The whole was then stirred vigorously using an Ultra-Turrax S-25N 18G stirrer for 2 minutes at 9500 rpm and then stirred using a paddle at 1000 rpm for 1 minute. Each emulsification is performed on 200 g in total.

The emulsions were then transferred into a plastic container, the container was closed and the emulsions were stored at −20° C. for the time indicated.

The mean and maximum droplet sizes, by volume, over a period of 6 months, and also the concentration of organic peroxide at the top and bottom of the aqueous phase of the emulsion (as weight percentages relative to the total weight of the aqueous phase) were determined, as indicated below.

The mean droplet size and the maximum droplet size are determined via conventional means using the light scattering technique. The measurements are taken using a Malvern MasterSizer 2000® device at room temperature. The mean droplet size and the maximum droplet size are given with an accuracy of +0.5 μm (micrometer).

After 6 months of storage at −20° C., a sample from the top of the emulsion (taken from the first centimeter below the emulsion surface) and a sample from the bottom of the emulsion (taken from the first centimeter from the bottom of the emulsion) were taken and analyzed to determine the organic peroxide concentration. The concentrations of organic peroxide in the aqueous phase were determined on a Waters H-class UPLC machine with an accuracy of +1%.

The results are presented in the tables below.

TABLE 3

| Composition No. | | | | |
|---|---|---|---|---|
| 1 | 2 | 3 | 4 | 5 |

After preparation of the emulsion (T₀)

| | | | | | |
|---|---|---|---|---|---|
| Mean | 1.5 | 1 | 1.5 | 3.7 | 1 |
| droplet size | | | | | |
| (μm) | | | | | |
| Maximum | 5 | 2.5 | 7.6 | 14.1 | 3.3 |
| droplet size | | | | | |
| (μm) | | | | | |

At T₀ + 1 month

| | | | | | |
|---|---|---|---|---|---|
| Mean | 1 | 1.1 | Not | 3.2 | 1.1 |
| droplet size | | | measurable | | |
| (μm) | | | due to | | |
| Maximum | 4.4 | 3.3 | demixing | 13.2 | 3.3 |
| droplet size | | | after a | | |
| (μm) | | | period of | | |
| | | | about 3 | | |
| | | | weeks | | |

At T₀ + 2 months

| | | | | | |
|---|---|---|---|---|---|
| Mean | 1.8 | Not | Not | 3.2 | 1.1 |
| droplet size | | measurable | measurable | | |
| (μm) | | due to | due to | | |
| Maximum | 5 | demixing | demixing | 13.2 | 3.8 |
| droplet size | | after a | | | |
| (μm) | | period of | | | |
| | | about 2 | | | |
| | | months | | | |

At T₀ + 3 months

| | | | | | |
|---|---|---|---|---|---|
| Mean | 1.4 | Not | Not | 3 | 1.2 |
| droplet size | | measurable | measurable | | |
| (μm) | | due to | due to | | |
| Maximum | 4.4 | demixing | demixing | 13.2 | 3.8 |
| droplet size | | | | | |
| (μm) | | | | | |

At T₀ + 4 months

| | | | | | |
|---|---|---|---|---|---|
| Mean | 1.7 | Not | Not | 3.3 | 1 |
| droplet size | | measurable | measurable | | |
| (μm) | | due to | due to | | |
| Maximum | 5 | demixing | demixing | 13.2 | 4.4 |
| droplet size | | | | | |
| (μm) | | | | | |

At T₀ + 5 months

| | | | | | |
|---|---|---|---|---|---|
| Mean | 1.4 | Not | Not | 3 | 1.3 |
| droplet size | | measurable | measurable | | |
| (μm) | | due to | due to | | |
| Maximum | 4.4 | demixing | demixing | 13.2 | 3.8 |
| droplet size | | | | | |
| (μm) | | | | | |

At T₀ + 6 months

| | | | | | |
|---|---|---|---|---|---|
| Mean | 1.3 | Not | Not | 3.2 | 1.1 |
| droplet size | | measurable | measurable | | |
| (μm) | | due to | due to | | |
| Maximum | 4.4 | demixing | demixing | 13.2 | 4.4 |
| droplet size | | | | | |
| (μm) | | | | | |
| Concentration | 49.5 | | | Not | 49.3 |
| at the top (%) | | | | measured | |
| Concentration | 48.9 | | | | 49.6 |
| at the bottom | | | | | |
| (%) | | | | | |

TABLE 4

| Composition No. | | | |
|---|---|---|---|
| 6 | 7 | 8 | 9 |

After preparation of the emulsion (T₀)

| | | | | |
|---|---|---|---|---|
| Viscosity cup | 90 | 23 | Not | 24 |
| at 5° C. (s) | | | measurable | |
| Mean | 1.9 | 2.1 | due to | 2.1 |
| droplet size | | | demixing after | |
| (μm) | | | a period of | |
| Maximum | 5.8 | 5.8 | about 2 hours | 6.6 |
| droplet size | | | | |
| (μm) | | | | |

At T₀ + 1 months

| | | | | |
|---|---|---|---|---|
| Mean | Not | 2.1 | Not | 2.2 |
| droplet size | measured | | measurable | |
| (μm) | | | due to | |
| Maximum | | 5.8 | demixing | 6.6 |
| droplet size | | | | |
| (μm) | | | | |

At T₀ + 2 months

| | | | | |
|---|---|---|---|---|
| Mean | 3.2 | 2.2 | Not | 2.5 |
| droplet size | | | measurable | |
| (μm) | | | due to | |
| Maximum | 15.1 | 5.8 | demixing | 6.6 |
| droplet size | | | | |
| (μm) | | | | |

At T₀ + 3 months

| | | | | |
|---|---|---|---|---|
| Mean | 5.8 | 2.2 | Not | 2.4 |
| droplet size | | | measurable | |
| (μm) | | | due to | |
| Maximum | 15.1 | 6.6 | demixing | 6.6 |
| droplet size | | | | |
| (μm) | | | | |

At T₀ + 4 months

| | | | | |
|---|---|---|---|---|
| Mean | 6.2 | 2.2 | Not | 2.6 |
| droplet size | | | measurable | |
| (μm) | | | due to | |
| Maximum | 17.4 | 6.6 | demixing | 7.6 |
| droplet size | | | | |
| (μm) | | | | |

At T₀ + 5 months

| | | | | |
|---|---|---|---|---|
| Mean | 6.6 | 2.2 | Not | 2.8 |
| droplet size | | | measurable | |
| (μm) | | | due to | |
| Maximum | 17.4 | 6.6 | demixing | 7.6 |
| droplet size | | | | |
| (μm) | | | | |

At T₀ + 6 months

| | | | | |
|---|---|---|---|---|
| Mean | 6.9 | 2.2 | Not | 2.9 |
| droplet size | | | measurable | |
| (μm) | | | due to | |
| Maximum | 20.0 | 6.6 | demixing | 7.6 |
| droplet size | | | | |
| (μm) | | | | |
| Concentration | 48.3 | 48.9 | | 49.7 |
| at the top (%) | | | | |
| Concentration | 50.3 | 49.1 | | 49.6 |
| at the bottom | | | | |
| (%) | | | | |

Emulsion 1 according to the invention is found to be more stable than comparative emulsion 2 comprising ethanol, which demixes after 2 months of storage. In addition, the mean and maximum droplet sizes of emulsion 1 according to the invention remain small over a period of at least 6 months.

Compared with comparative emulsion 3 which contains ethanol, emulsions 4 and 5 according to the invention are stable over a period of at least 6 months, with mean and maximum droplet sizes remaining small throughout this period. Comparative emulsion 3, on the other hand, demixed after only 3 weeks.

In addition, emulsions 1 and 5 according to the invention have similar organic peroxide concentrations at the top and bottom of the aqueous phase after 6 months: they remained homogeneous over this period.

Comparative emulsion 8 comprising ethanol undergoes demixing as early as 2 hours after preparation, while emulsions 7 and 9 according to the invention remain stable over a period of more than 6 months, while at the same time retaining small mean and maximum droplet sizes. In addition, these emulsions 7 and 9 remained homogeneous after 6 months, with similar concentrations of organic peroxide at the top and bottom of the aqueous phase. Little or no sedimentation of organic peroxide droplets thus took place. Furthermore, compared with comparative emulsion 6 comprising hydrolyzed polyvinyl acetate, emulsions 7 and 9 had much smaller mean and maximum droplet sizes after 2 months.

### Example 2

The following emulsions were prepared (the amounts indicated in the table below are expressed as mass percentages relative to the total weight of the emulsion):

TABLE 5

| | Composition No. | | | | |
|---|---|---|---|---|---|
| | 10 | 11 | 12 | 13 | 14 |
| Surfaline R20 | 1.2% | 1.2% | 1.2% | 1.2% | 1.2% |
| Methanol | 12.1% | | 11.3% | | |
| Propane-1,2-diol | | 21.4% | 2.8% | 8.8% | 19.1% |
| 2-Propanol | | | | 8.3% | |
| Demineralized water | qs 100 | qs 100 | qs 100 | qs 100 | qs 100 |
| Luperox 223 | 60.0% | 59.9% | 59.9% | 60.0% | 60.0% |

qs 100 = quantity sufficient to reach 100% of the weight of the emulsion.

The nature of the compounds used is indicated below:
Luperox® 223: bis(2-ethylhexyl) peroxydicarbonate
Surfaline R20: nonionic surfactant, ethoxylated castor oil (20 OE) (HLB: 9.6).

Emulsions 11, 13 and 14 correspond to emulsions according to the invention, and emulsions 10 and 12 are comparative emulsions.

The emulsions were prepared as described in Example 1.

The mean and maximum droplet sizes, by volume, were determined after production of the emulsions and after 2 months of storage, as indicated in Example 1.

The results are presented in the following table:

TABLE 6

| Composition No. | | | | |
|---|---|---|---|---|
| 10 | 11 | 12 | 13 | 14 |

After preparation of the emulsion (T₀)

| | | | | | |
|---|---|---|---|---|---|
| Mean | 5 | 1.2 | 4.8 | 1 | 1.1 |
| droplet size (μm) | | | | | |
| Maximum | 17.4 | 3.3 | 15.1 | 2.9 | 3.8 |
| droplet size (μm) | | | | | |

At T₀ + 2 months

| | | | | | |
|---|---|---|---|---|---|
| Mean | 4.9 | 1.3 | 4.8 | 3.3 | 1.2 |
| droplet size (μm) | | | | | |
| Maximum | 17.4 | 3.3 | 15.1 | 8.7 | 3.8 |
| droplet size (μm) | | | | | |

Emulsions 11, 13 and 14 according to the invention are found to be stable over a period of at least two months.

Emulsions 11, 13 and 14 according to the invention have a smaller mean droplet size and a smaller maximum droplet size than the comparative emulsions comprising methanol (emulsions 10 and 12), both immediately after preparation of the emulsion and after two months.

1-15. (canceled)

16. An organic peroxide emulsion comprising:
at least one organic peroxide;
at least one emulsifier comprising at least one nonionic surfactant comprising at least one fatty chain and having an HLB of less than or equal to 18;
at least one antifreeze with a dynamic viscosity at 20° C. ranging from 40 mPa·s to 100 mPa·s;
from 0 to 1% of polyvinyl acetate; and
water;
and in which, when said emulsion comprises at least one alcohol selected from the group consisting of methanol, ethanol, ethylene glycol and diethylene glycol, said alcohol is present in a mass ratio strictly less than 1, relative to said at least one antifreeze with a dynamic viscosity at 20° C. ranging from 40 mPa·s to 100 mPa·s.

17. The emulsion as claimed in claim 16, consisting of the at least one organic peroxide, the at least one emulsifier, the at least one antifreeze, water, and optionally one or more additives selected from the group consisting of antifoams, chain-transfer agents, chain extenders, pH regulators, plasticizers, and mixtures thereof.

18. The emulsion as claimed in claim 16, in which the at least one antifreeze is an alcohol.

19. The emulsion as claimed in claim 16, in which the at least one antifreeze is selected from the group consisting of propane-1,2-diol, propane-1,3-diol, triethylene glycol and mixtures thereof.

20. The emulsion as claimed in claim 16, in which the at least one antifreeze comprises a mixture of propane-1,2-diol and 2-propanol.

21. The emulsion as claimed in claim 20, in which the mass ratio of propane-1,2-diol to 2-propanol is strictly greater than 1 and less than 4.

22. The emulsion as claimed in claim 16, in which the at least one antifreeze is present in an amount of from 10% to 40% by weight, relative to the total weight of the emulsion.

23. The emulsion as claimed in claim 16, in which the at least one organic peroxide is selected from the group consisting of peroxydicarbonates, peroxyesters, diacyl peroxides and combinations thereof.

24. The emulsion as claimed in claim 16, in which the at least one organic peroxide is selected from the group consisting of tert-amyl peroxypivalate, tert-butyl peroxypivalate, tert-butyl peroxyneodecanoate, tert-amyl peroxyneodecanoate, 3-hydroxy-1,1-dimethylbutyl peroxyneodecanoate, cumyl peroxyneodecanoate, di-sec-butyl peroxydicarbonate, bis(2-ethylhexyl) peroxydicarbonate, bis(3,5,5-trimethylhexanoyl) peroxide, and mixtures thereof.

25. The emulsion as claimed in claim 16, in which the at least one organic peroxide is present in a content ranging from 40% to 80% by weight, relative to the total weight of the emulsion.

26. The emulsion as claimed in claim 16, in which the at least one nonionic surfactant is selected from the group consisting of oxyalkylenated fatty alcohols, oxyalkylenated fatty acids, oxyalkylenated plant or animal oils, polysorbates, sorbitan esters, alkyl glucosides, oxyalkylenated alkyl glucosides and mixtures thereof.

27. The emulsion as claimed in claim 16, said emulsion not being:
a composition consisting of 50% by weight of di-sec-butyl peroxydicarbonate, 1.44% by weight of ethoxylated castor oil with a mean degree of ethoxylation of 31, and 21.4% by weight of propane-1,2-diol, the remainder being water;
a composition consisting of 50% by weight of di-sec-butyl peroxydicarbonate, 1.5% by weight of ethoxylated castor oil with a mean degree of ethoxylation of 20, and 21.4% by weight of propane-1,2-diol, the remainder being water;
a composition consisting of 50% by weight of di-sec-butyl peroxydicarbonate, 1.5% by weight of ethoxylated castor oil with a mean degree of ethoxylation of 20, 21.4% by weight of propane-1,2-diol and 3% of 3-hydroxy-1,1-dimethylbutyl peroxyneodecanoate, the remainder being water; and
a composition consisting of 50% by weight of di-sec-butyl peroxydicarbonate, 1.5% by weight of ethoxylated castor oil with a mean degree of ethoxylation of 20, 21.4% by weight of propane-1,2-diol and 11.5% of 3-hydroxy-1,1-dimethylbutyl peroxyneodecanoate, the remainder being water.

28. A process for preparing an emulsion as claimed in claim 16, comprising a step of mixing the at least one organic peroxide, the at least one emulsifier, the at least one antifreeze and water; and optionally, a step of emulsifying the mixture.

29. A process for polymerization or copolymerization of one or more ethylenically unsaturated monomers comprising using the emulsion as claimed in claim 16.

30. A halogenated vinyl polymer obtained by polymerization of at least one ethylenically unsaturated monomer in the presence of the emulsion as claimed in claim 16.
